(19) United States
(12) Patent Application Publication
(10) Pub. No.: US 2018/0367358 A1
(43) Pub. Date: Dec. 20, 2018

(54) USER EQUIPMENT RELATED REFERENCE SIGNAL DESIGN, TRANSMISSION AND RECEPTION

(71) Applicants: MOHAMMADHADI BALIGH, OTTAWA (CA); KELVIN KAR KIN AU, KANATA (CA); AMINE MAAREF, OTTAWA (CA); KEYVAN ZARIFI, OTTAWA (CA); YICHENG LIN, OTTAWA (CA)

(72) Inventors: MOHAMMADHADI BALIGH, OTTAWA (CA); KELVIN KAR KIN AU, KANATA (CA); AMINE MAAREF, OTTAWA (CA); KEYVAN ZARIFI, OTTAWA (CA); YICHENG LIN, OTTAWA (CA)

(73) Assignee: HUAWEI TECHNOLOGIES CO., LTD., SHENZHEN (CN)

(21) Appl. No.: 15/802,326

(22) Filed: Nov. 2, 2017

Related U.S. Application Data
(60) Provisional application No. 62/519,750, filed on Jun. 14, 2017.

(51) Int. Cl. H04L 27/26; H04L 5/00; H04W 72/04; H04B 7/06

(52) U.S. Cl. CPC H04L 27/2613; H04L 5/0048; H04W 72/0413; H04J 13/0062; H04B 7/0626; H04L 5/0023; H04W 72/0446; H04L 5/0057

(57) ABSTRACT

Systems and methods for reference signal transmission, such as demodulation reference symbol and CSI-RS. The network transmits a reference signal scrambling ID to the UE, and both the network and the UE use this to calculate an initialization sequence for the reference signal. The, one or the other of the network and the UE transmit the reference signal. Optionally, the reference signal is based on a UE-related ID, or a combination of the UE-related ID and one or more other fields.

### CROSS-REFERENCE TO RELATED APPLICATION

This application claims the benefit of U.S. Provisional Patent Application No. 62/519,750 entitled “User Equipment Related Reference Signal Design, Transmission and Reception” filed Jun. 14, 2017, the entire content of which is incorporated herein by reference.

### FIELD

The present disclosure relates generally to wireless communications, and in particular embodiments, to systems and methods for user equipment related reference signal design, transmission and reception.

### BACKGROUND

In traditional cellular networks, each transmit/receive point (TRP) is associated with a coverage area or a traditional TRP-based cell and is assigned a traditional cell identifier (ID) to define the control channel and data channel so that simultaneous TRP to user equipment (UE) or UE to TRP communications can be supported for each traditional cell. The network may maintain the association between serving TRP and the UE through assigned traditional cell ID until a handover is triggered.

As the demand on mobile broadband increases, traditional cellular networks are deployed more densely and heterogeneously with a greater number of TRPs. Traditional cell ID assignment becomes more difficult and the occurrence rate of handovers increases as the UE moves between TRPs. Further, the density of the traditional cells creates much interference between neighboring traditional cells.

Existing cell-specific reference signal configurations are not well suited for dense networks featuring either very small cells, or multiple TRPs in a cell.

### SUMMARY

Embodiments of the invention provide systems and methods for transmitting UE related reference signals, also referred to herein as reference symbols.

A broad aspect of the disclosure provides a method comprising: transmitting, from a first transmit/receive point (TRP) in a multi-TRP cell, to a first user equipment (UE), a first wireless reference signal based on a UE-related identification (ID) associated with the first UE; and transmitting, from a second TRP in the multi-TRP cell, to a second UE, a second wireless reference signal based on a UE-related ID associated with the second UE. Optionally, each UE-related ID initially defaults to a UE ID.

Another broad aspect of the disclosure provides in a method in a cell comprising at least one transmit receive point (TRP), the method comprising: transmitting from at least one TRP, to a UE, a wireless reference signal based on a UE-related ID associated with the UE; wherein the UE-related ID initially defaults to a UE ID of the UE.

Another broad aspect of the disclosure provides a method comprising: receiving, at a user equipment (UE), a wireless reference signal based on a UE-related identification (ID), wherein the UE-related ID is associated with the UE; wherein the UE-related ID initially defaults to a UE ID of the UE

Another broad aspect of the disclosure provides a method comprising: transmitting, from a user equipment (UE) to at least one transmit/receive point (TRP) in a multi-TRP cell, a wireless reference signal based on a UE-related identification (ID), wherein the UE-related ID is associated with the UE; wherein the UE-related ID initially defaults to a UE ID.

Another broad aspect of the disclosure provides a method comprising: receiving, at a first transmit/receive point (TRP) in a multi-TRP cell, from a first user equipment (UE), a first wireless reference signal based on a first UE-related identification (ID) associated with the first UE; and receiving, at a second TRP in the multi-TRP cell, from a second UE, a second wireless reference signal based on a UE-related ID associated with the second UE. Optionally, each UE-related ID initially defaults to a UE ID.

Another broad aspect of the disclosure provides a method performed by at least one transmit receive point (TRP), the method comprising: receiving by at least one TRP, from a UE, a wireless reference signal based on a UE-related ID associated with the UE; wherein the UE-related ID initially defaults to a UE ID of the UE.

Optionally, for any of the above summarized embodiments, each wireless reference signal is based on the UE-related ID in that a PN sequence associated with the wireless reference signal is initialized with an initialization sequence containing some or all of the UE-related ID.

Optionally, for any of the above summarized embodiments, the PN sequence is directly associated with the wireless reference signal.

Optionally, for any of the above summarized embodiments, the PN sequence is used to configure a Zadoff Chu sequence that in turn is directly associated with the wireless reference signal.

Optionally, for any of the above summarized embodiments, each wireless reference signal is based on the UE-related ID in that at least one of:

resource elements used to transmit the RS;

periodicity; and

density in time and frequency;

is dependent on the UE related ID.

Optionally, for any of the above summarized embodiments, at least one wireless reference signal is a demodulation reference symbol (DMRS) transmitted together with data or control information.

Optionally, for any of the above summarized embodiments, at least one wireless reference signal is a channel state information (CSI)-RS transmitted separate from data or control information.

Optionally, for any of the above summarized embodiments, at least one wireless reference signal is a sounding reference symbol (SRS) transmitted separate from data or control information.

Optionally, for any of the above summarized embodiments, after the UE-related ID initially defaults to the UE ID, the UE-related ID is configured to be a shared UE ID.

Optionally, for any of the above summarized embodiments, the method further comprises: configuring the UE-related ID to be a configurable ID, and thereafter transmitting or receiving the wireless reference signal based on a

UE-related ID set to the configurable ID.

Optionally, for any of the above summarized embodiments, the wireless reference signal is also a function of a cell ID.

Optionally, for any of the above summarized embodiments, the wireless reference signal is a function of a cell ID in that: a PN sequence associated with the wireless reference signal is initialized with an initialization sequence containing some or all of the cell ID.

Optionally, for any of the above summarized embodiments, the wireless reference signal is a function of a cell ID in that: a cell specific cover code is applied to the wireless reference signal.

Optionally, for any of the above summarized embodiments, the wireless reference signal is based on a UE-related ID that is shared between a group of UEs, with a cover code that is specific to the UE and not shared by the group of UEs.

Optionally, for any of the above summarized embodiments, the wireless reference signal is based on a UE related ID in that a subset of a UE related ID is used for PN sequence initialization, and a remaining portion of the UE related ID specifies a resource element pattern or a cover code or some other configuration to differentiate between UEs.

Optionally, for any of the above summarized embodiments, for multi-user MIMO, for co-paired UEs, after initially using a respective UE-related ID set to a respective UE ID for each UE, a configurable ID is used for DMRS for the co-paired users together with a respective different cover code for each UE for UE separation.

Further embodiments provide a UE, or a TRP, or a cell comprising a plurality of TRPs, configured to perform one or a combination of the above-summarized methods.

According to another aspect of the present invention, there is provided a method for non-random access communication, the method comprising: transmitting, from a transmit/receive point (TRP), to a user equipment (UE), a reference signal (RS) scrambling identification (ID) associated with the UE; calculating a RS initialization sequence based on the RS scrambling ID; and communicating a reference signal between the UE and the TRP, the reference signal based on the RS initialization sequence.

Optionally, the method further comprises: transmitting, from the TRP to the UE, at least one of: a cell ID, a slot number, a symbol number, a RS type, a cyclic prefix type, or a transmission channel; and wherein calculating the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, communicating the reference signal comprises receiving, by the TRP, a received reference signal from the UE.

Optionally, the method further comprises combining the received reference signal with the calculated RS initialization sequence, for measuring an uplink channel of the received reference signal.

Optionally, the reference signal is a demodulation reference symbol or a sounding reference symbol.

Optionally, communicating the reference signal comprises transmitting, by the TRP, the reference signal to the UE.

Optionally, the reference signal is a demodulation reference symbol or a channel state information reference signal.

According to another aspect of the present invention, there is provided a method for non-random access communication, the method comprising: receiving, by a user equipment (UE), from a transmit/receive point (TRP), a reference signal (RS) scrambling identification (ID) associated with the UE; calculating a RS initialization sequence based on the wireless RS scrambling ID; and communicating a reference signal between the UE and the TRP, the reference signal based on the RS initialization sequence.

Optionally, the method of claim 34, further comprises: receiving, from the TRP, at least one of: a cell ID, a slot number, a symbol number, a RS type, a cyclic prefix type, or a transmission channel; and wherein calculating the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, communicating the reference signal comprises receiving, by the UE, a received reference signal from the TRP.

Optionally, the method further comprises combining the received reference signal with the calculated RS initialization sequence, for measuring a downlink channel of the received reference signal.

Optionally, the reference signal is a demodulation reference symbol or a channel state information reference signal.

Optionally, communicating the reference signal comprises transmitting, by the UE, the reference signal to the TRP.

Optionally, the reference signal is a demodulation reference symbol or a sounding reference symbol.

According to another aspect of the present invention, there is provided a transmit/receive point (TRP) comprising: a transmitter and a receiver; a processing unit and memory; the TRP configured to transmit to a UE a reference signal (RS) scrambling identification (ID) associated with the UE, calculate a RS initialization sequence based on the RS scrambling ID, and communicate a reference signal between the UE and the TRP, the reference signal based on the RS initialization sequence.

Optionally, the RS scrambling ID is based on a UE-related ID that is associated with the first UE.

Optionally, the TRP is configured to communicate the reference signal by receiving the reference signal from the UE.

Optionally, the TRP is configured to communicate the reference signal by transmitting the reference signal to the UE.

According to another aspect of the present invention, there is provided a user equipment (UE) comprising: a transmitter and a receiver; a processing unit and memory; the UE configured to receive from a transmit/receive point (TRP), a reference signal (RS) scrambling identification (ID) associated with the UE, to calculate a RS initialization sequence based on the RS scrambling ID, and to communicate a reference signal between the UE and the TRP, the reference signal based on the RS initialization sequence.

Optionally the RS scrambling ID is based on a UE-related ID that is associated with the first UE.

Optionally, the UE is configured to communicate the reference signal by receiving the reference signal from the TRP.

Optionally, the UE is configured to communicate the reference signal by transmitting the reference signal to the TRP.

According to another aspect of the present invention, there is provided a method for non-random access communication, the method comprising: transmitting, from a first user equipment (UE), to a second UE, a reference signal (RS) scrambling identification (ID) associated with the second UE; calculating a RS initialization sequence based on the RS scrambling ID; and transmitting a reference signal from the first UE to the second UE, the reference signal based on the RS initialization sequence.

Optionally, the method further comprises: transmitting, from the first UE to the second UE, at least one of: a cell ID, a slot number, a symbol number, a RS type, a cyclic prefix type, or a transmission channel; and wherein calculating the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, the reference signal is a demodulation reference symbol or a channel state information reference signal.

According to another aspect of the present invention, there is provided a method for non-random access communication, the method comprising: receiving, by a second user equipment (UE) from a first UE, a reference signal (RS) scrambling identification (ID) associated with the second UE; calculating a RS initialization sequence based on the RS scrambling ID; and receiving, by the second UE from the first UE, a reference signal based on the RS initialization sequence.

Optionally, the method further comprises: receiving, by the second UE from the first UE, at least one of: a cell ID, a slot number, a symbol number, a RS type, a cyclic prefix type, or a transmission channel; and wherein calculating the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, the method further comprises combining the received reference signal with the calculated RS initialization sequence, for measuring a sidelink channel of the received reference signal.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates an example communication system in which embodiments of the present disclosure could be implemented;

FIG. 2 illustrates two neighboring new radio (NR) cells of an example communication system in which embodiments of the present disclosure could be implemented;

FIG. 3 illustrates how initialization sequences for DMRS and CSI-RS are generated in LTE;

FIG. 4 illustrates how initialization sequence are generated based on UE related IDs in accordance with an embodiment of the disclosure;

FIGS. 5 to 9 are flowcharts of methods provided by embodiments of the disclosure;

FIG. 10A is block diagram of an example of a base station that may be configured to implement one or more of the embodiments described herein;

FIG. 10B is block diagram of an example of a UE that may be configured to implement one or more of the embodiments described herein;

FIG. 11 is a call flow diagram for a downlink call flow;

FIG. 12 is a call flow diagram for an uplink call flow;

FIG. 13 is a call flow diagram for a sidelink call flow.

### DETAILED DESCRIPTION

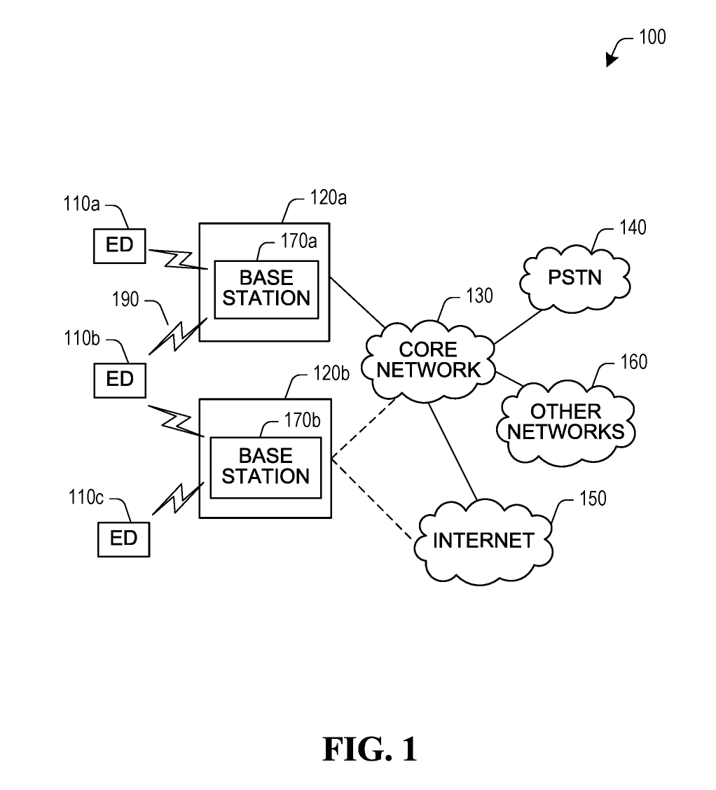

FIG. 1 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the Internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB (sometimes called a “gigabit” NodeB), a transmission point (TP), a transmit/receive point (TRP), a site controller, an access point (AP), or a wireless router. Any ED 110a-110c may be alternatively or jointly configured to interface, access, or communicate with any other base station 170a-170b, the internet 150, the core network 130, the PSTN 140, the other networks 160, or any combination of the preceding. Optionally, the system may include RANs, such as RAN 120b, wherein the corresponding base station 170b accesses the core network 130 via the internet 150, as shown.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b may be configured to operate to transmit and/or receive wireless signals within a particular geographic region or area, sometimes referred to as a coverage area. A cell may be further divided into cell sectors, and a base station 170a-170b may, for example, employ multiple transceivers to provide service to multiple sectors. In some embodiments a base station 170a-170b may be implemented as pico or femto nodes where the radio access technology supports such. In some embodiments, multiple-input multiple-output (MIMO) technology may be employed having multiple transceivers for each coverage area. The number of RAN 120a-120b shown is exemplary only. Any number of RAN may be contemplated when devising the system 100.

The base stations 170a-170b communicate with one or more of the EDs 110a-110c over one or more air interfaces 190 using wireless communication links e.g. RF, μWave, IR, etc. The air interfaces 190 may utilize any suitable radio access technology. For example, the system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. Understandably, the RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the Internet 150, and the other networks 160). In addition, some or all of the EDs 110a-110c may include functionality for communicating with different wireless networks over different wireless links using different wireless technologies and/or protocols. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

It is contemplated that the communication system 100 as illustrated in FIG. 1 may support a New Radio (NR) cell, which also may be referred to as hyper cell. Each NR cell includes one or more TRPs using the same cell ID (e.g. NR cell ID). The NR cell ID is a logical assignment to all physical TRPs of the NR cell and may be carried in a broadcast synchronization signal. The NR cell may be dynamically configured. The boundary of the NR cell may be flexible and the system dynamically adds or removes TRPs to from the NR cell.

In one embodiment, a NR cell may have one or more TRPs within the NR cell transmitting a UE-specific data channel, which serves a UE. The one or more TRPs associated with the UE specific data channel are also UE specific and are transparent to the UE. Multiple parallel data channels within a single NR cell may be supported, each data channel serving a different UE.

In another embodiment, a broadcast common control channel and a dedicated control channel may be supported. The broadcast common control channel may carry common system configuration information transmitted by all or partial TRPs sharing the same NR cell ID. Each UE can decode information from the broadcast common control channel in accordance with information tied to the NR cell ID. One or more TRPs within a NR cell may transmit a UE specific dedicated control channel, which serves a UE and carries UE-specific control information associated with the UE. Multiple parallel dedicated control channels within a single NR cell may be supported, each dedicated control channel serving a different UE. The demodulation of each dedicated control channel may be performed in accordance with a UE-specific reference signal (RS), the sequence and/or location of which are linked to the UE ID or other UE specific parameters.

In some embodiments, one or more of these channels, including the dedicated control channels and the data channels, may be generated in accordance with a UE specific parameter, such as a UE ID, and/or an NR cell ID. Further, the UE specific parameter and/or the NR cell ID can be used to differentiate transmissions of the data channels and control channels from different NR cells.

An ED, such as a UE, may access the communication system 100 through at least one of the TRP within a NR cell using a UE dedicated connection ID, which allows one or more physical TRPs associated with the NR cell to be transparent to the UE. The UE dedicated connection ID is an identifier that uniquely identifies the UE in the NR cell. For example, the UE dedicated connection ID may be identified by a sequence. In some implementations, the UE dedicated connection ID is assigned to the UE after an initial access. The UE dedicated connection ID, for example, may be linked to other sequences and randomizers which are used for PHY channel generation.

In some embodiments, the UE dedicated connection ID remains the same as long as the UE is communicating with a TRP within the NR cell. In some embodiments, the UE can keep original UE dedicated connection ID when crossing NR cell boundary. For example, the UE can only change its UE dedicated connection ID after receiving signaling from the network.

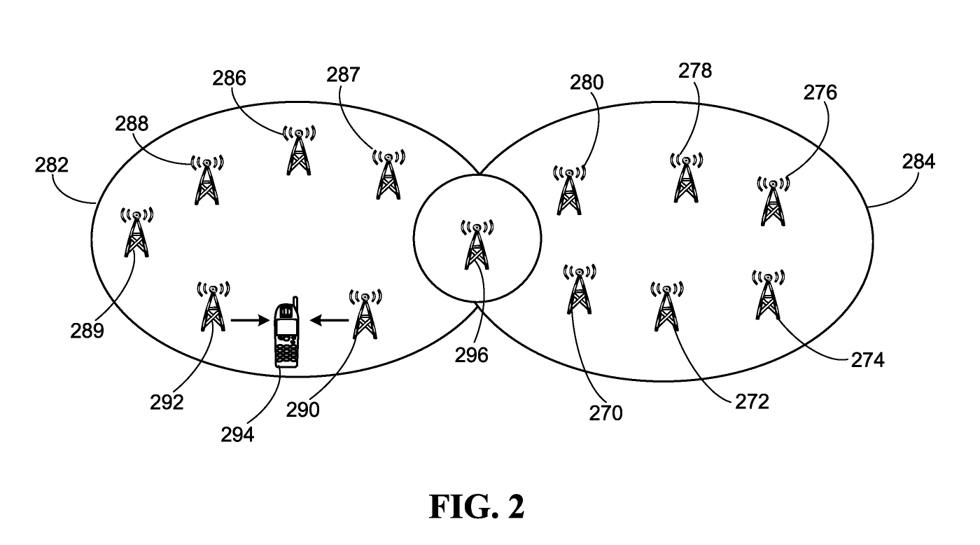

It is obviously understood that any number of NR cells may be implemented in the communication system 100. For example, FIG. 2 illustrates two neighboring NR cells in an example communication system, in accordance with an embodiment of the present disclosure.

As illustrated in FIG. 2, NR cells 282, 284 each includes multiple TRPs that are assigned the same NR cell ID. For example, NR cell 282 includes TRPs 286, 287, 288, 289, 290, and 292, where TRPs 290, 292 communicates with an ED, such as UE 294. It is obviously understood that other TRPs in NR cell 282 may communicate with UE 294. NR cell 284 includes TRPs 270, 272, 274, 276, 278, and 280. TRP 296 is assigned to NR cells 282, 284 at different times, frequencies or spatial directions and the system may switch the NR cell ID for transmit point 296 between the two NR cells 282 and 284. It is contemplated that any number (including zero) of shared TRPs between NR cells may be implemented in the system.

The system may apply TRP selection techniques to minimize intra-NR cell interference and inter-NR cell interference. In one embodiment, a TRP sends a downlink channel state information (CSI)-reference symbol (RS). Some pilot (also known as reference signal) ports may be defined such that the UEs can measure the channel state information and report it back to the network. A CSI-RS port is a pilot port defined as a set of known symbols from a sequence transmitted over known resource elements (for example OFDM resource elements) for UEs to measure the channel state. A UE assigned to measure a particular CSI-RS port can measure the transmitted CSI-RS sequence, measure the associated channel state and report it back to the network. The network, such as a controller, may select the best TRPs for all served UEs based on the downlink measurements. In another embodiment, a TRP detects an uplink sounding reference signal (SRS) sequence from a UE in the configured time-frequency resources. For example, Constant Amplitude Zero Auto Correlation (CAZAC) sequences such as ZC sequences can be used as base sequences for SRS. The TRP reports a measurement of the detected uplink SRS sequence to the network, such as a controller. The controller then selects the optimal TRPs for all served UEs based on the measurements.

Reference signals used in the wireless communication system and cell of FIGS. 1 and 2 have two main purposes. The first purpose is to assist with data demodulation. Reference signals for this purpose are sent along with the data/control, typically using time/frequency resources close to those used for the data, and the receiver can use these symbols to estimate the channel over which the data was received. Such symbols are referred to herein generally as demodulation reference symbols (DMRS). These can be transmitted on the uplink and downlink in association with data or control information.

The second purpose is for longer term channel state information acquisition. Reference signals for this purpose do not typically accompany data or control information. On the downlink, the network transmits reference signals to the UE, and the UE makes channel measurements and reports back to the network. These are referred to herein as downlink (DL) channel state information—reference symbols (CSI-RS). On the uplink the UE transmits reference signals to the network, and the network makes measurements based on these. Typically, the network does not report back to the UE. These are referred to herein as uplink sounding reference symbols (SRS).

A third less common usage of reference signals is for beamforming management. DL CSI-RS can be used for this purpose.

SRS is specific to a particular UE, in the sense that a particular UE transmits it, and the network makes measurements specific to that UE. UL and DL DMRS are also specific to particular UE in the sense that it is transmitted along with UL or DL data to/from a specific UE.

DMRS for co-paired users in MU-MIMO may be designed to be (almost) orthogonal through resource assignment for DRMS transmission to/from the co-paired UEs, and/or sequence assignment for DMRS transmission to/from the co-paired UEs.

CSI-RS may be UE specific or shared between a few UEs. With a shared CSI-RS, multiple UEs measure the same CSI-RS. This may be employed, for example, for a community CSI-RS for TRPs in a hotspot.

UE specific CSI-RS has been used for beam tracking and beam refinement. In this case, the UE-specific CSI-RS is transmitted by a UE specific TRP set.

In LTE, all UL reference signals use Zadoff-Chu (ZC) sequences. Such sequences have two parameters, namely cyclic shift and root. The parameters are determined indirectly as a function of a pseudo-noise (PN) sequence which is a Gold sequence. As such specifying a PN sequence also specifies a ZC sequence. Transmissions make use of OFDM symbols. Each OFDM symbol has an OFDM symbol duration, in the time dimension, and a plurality of sub-carriers in the frequency dimension. A resource element is one sub-carrier for one OFDM symbol duration. The resource elements used to transmit the ZC sequence occupy a single ODFM symbol in the time dimension, and use consecutive or spaced sub-carriers in the frequency dimension. The PN sequences, which in turn are used to specify the ZC sequences, have initialization sequences that are based on cell ID.

In LTE, all DL reference signals are based directly on PN sequences. Mainly, the DL reference signal uses a PN sequence that is initiated by cell ID or a configurable ID. The resource elements used to transmit DL reference sequences occupy a diamond shaped lattice.

In LTE, all the RS directly or indirectly use PN sequences to randomize the RS. The DL RS use directly the PN sequence for sequence generation. The UL RS use PN to derive or impact the root/cyclic shift of the RS. See for example, 3GPP TS 36.212 V13.5.0 (2017-03) hereby incorporated by reference.

The PN in LTE uses the addition of two gold sequences generated by polynomials X̂31+X̂3+1 and X̂31+X̂3+X̂2+X+1. The first polynomial is always initiated with 0x00000001 and the second one has 31 bits of initialization.

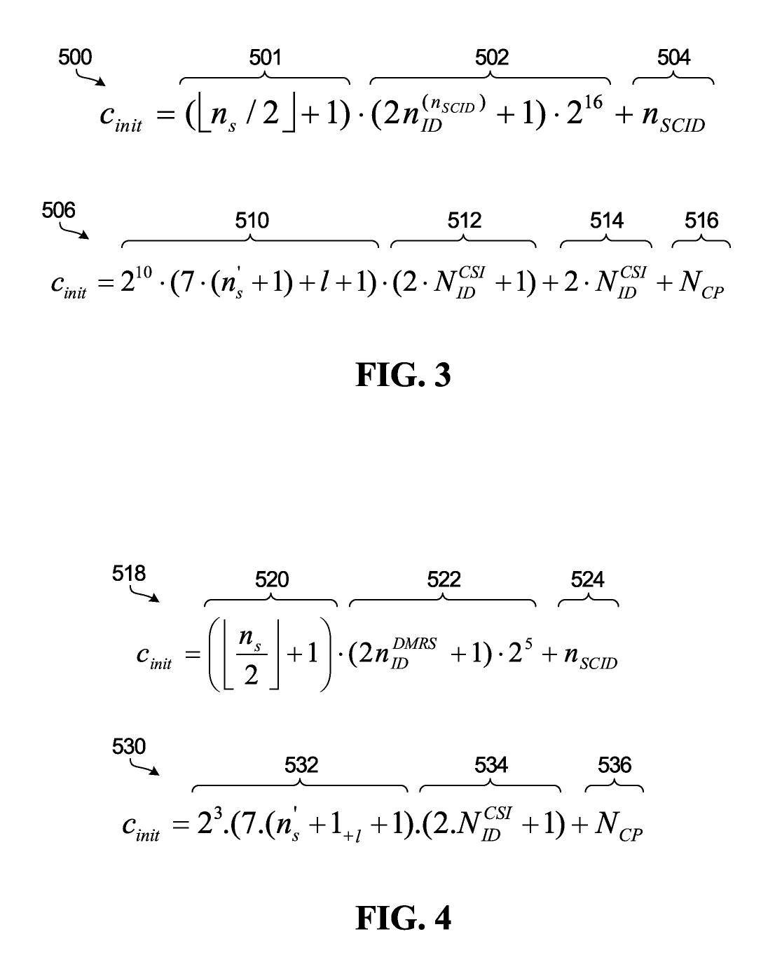

FIG. 3 shows the formula for the 31 bit initialization sequence cᵢₙᵢₜ for DMRS in LTE, generally indicated at 500. The initialization sequence is a function of three components, including a first component 501 based on the slot number nₛ, a second component 502 which is a RS scrambling ID that is based on a 9 bit cell n_{ID}^{nSCID}, and a third component containing n_{SCID} in bit position 0 which can be 0 or 1 followed by 15 unused bits. As used in herein, an RS scrambling ID is a part of the initialization sequence that is based one or more IDs. As detailed above, in LTE, the RS scrambling ID is based on cell ID.

FIG. 3 also shows the formula for the 31 bit initialization sequence cᵢₙᵢₜ for CSI-RS in LTE, generally indicated at 506. The initialization sequence is a function of three components, including a first component 510 based on the slot number nₛ, a second component 512 which is a RS scrambling ID that is based on a 9 bit cell ID n_{ID}^{nCSI}, and third component 514 also based on the cell ID, and a fourth component 516 containing n_{CP} which can be 0 or 1. Note that the formula includes a factor 2¹⁶ which is equivalent to a 16 bit shift.

Finally, it is noted that paging channels and system information channels are based on cell specific RS.

### UE Specific RS Design

In accordance with an embodiment of the invention, the network and UE are configured to use UE specific RS as the default mode of operation for one or a combination of CSI-RS, SRS, and UL DMRS and DL DMRS, optionally with subsequent configurability. A UE specific reference signal is UE specific in the sense that UE ID determines one, or a combination of RS attributes that include:

the RS sequence, in the sense that the RS sequence is initialized with an initialization sequence (also referred to as a seed) that is based in some manner (directly or indirectly) on at least some part of a UE related ID—the UE related ID can be one of:

a UE ID;

an ID configured for the UE, referred to hereinafter as a configurable ID, that defaults to the UE ID or part of the UE ID.

Other attributes of the RS, including one or more of pattern of resource elements used to transmit the RS, periodicity (periodic or on demand and if periodic, with what period) and density in time and frequency, may or may not depend on the UE related ID.

UE IDs may differ in different layers and some examples include:

C-RNTI which is valid in the Phy/Mac layer in a cell;

S-TMSI (SAE-Temporary Mobile Subscriber Identity) which is used for paging (higher layer);

IMSI (International Mobile Subscriber Identity) which is 64 bits (higher layer and unique in all networks) and in LTE is directly associated with the SIM card;

Other IDs such as IMEI (which is the unique serial number of the mobile device) exist and are more static.

Where a UE related RS are used for more than one of the purposes listed above (CSI-RS, SRS, UL DMRS, DL DMRS) the respective PN sequences are each based in some manner on a UE related ID, but not necessarily in the same manner. In some embodiments, initially, the RS is based on the UE ID is used by default, but this can be changed through over the air configuration. Configurability of the RS can be used, for example, to provide RS sharing or orthogonality.

In some embodiments, to avoid RS collision between adjacent cells, a cell-specific element is also used. This may involve using a cell ID as part of the initialization sequence, or as a cover code.

In some embodiments, a default configuration of the UE related RS is employed, at least prior to optional RRC signaling for RS re-configuration.

Some RS transmissions occur prior to completion of the initialization such as those associated with a physical random access channel (PRACH) procedure, and RRC signaling is not available for RS configuration during that time. Advantageously, through the use of a default setting, signaling overhead for the system using the UE ID as the UE related ID behavior is reduced.

Thus, a reference signal framework is provided having the following features:

a. default reference signal design is UE related using the UE ID for interference randomization among adjacent cells;
b. optionally, a cell specific ID may be used to further randomize the RS for UEs using the same UE related ID in adjacent cells;
c. optionally, RRC configuration may substitute UE ID with a configurable ID (preferably of the same width as UE ID). This may be to configured as a group specific RS or to facilitate RS optimization within a cell.

Similarly, a configurable ID can determine one or a combination of the same RS attributes. The configurable ID can be a UE group ID configured for multiple UEs in which case the multiple UEs share the RS.

### Examples of the RS Channels and DMRS Design

A specific example of how UE specific RS are used for DMRS during a paging phase, a pre-initialization phase (random access channel), during subsequent regular communication, and for system information transmission will now be described in detail.

Paging Phase—For network initiated communications, network access begins with a paging phase. The paging phase is not required for UE initiated communications. A paging radio network temporary identifier (P-RNTI) is shared by multiple UEs within a paging area containing multiple cells. The same P-RNTI is transmitted by multiple cells. In another embodiment, a network can configure an NR cell to cover a large geographic area containing many TRPs. The paging message can be transmitted in a single frequency network (SFN) manner whereby the transmitted signals from all TRPs are within the duration of a cyclic prefix length. In this case, the combined received signal by a UE has a good signal to interference plus noise ratio (SINR). These TRPs are configured with the same NR cell ID. UEs sharing the P-RNTI wake up to listen to the page, and if one is received, the UE goes on to perform the RACH procedure described below.

In accordance with an embodiment of the invention, the P-RNTI is used for DMRS for both PDSCH carrying the paging message and PDCCH for carrying control information (e.g. resource allocation) for paging message. In another embodiment in order to avoid interference and collision of RS between adjacent cells, P-RNTI and NR cell ID are used for DMRS for PDSCH carrying the paging message and PDCCH for carrying control information (e.g. resource allocation) for paging message. However, note that this is not UE-related, as the P-RNTI is a fixed community ID.

System Information—System Information broadcast messages are transmitted to all the users in the NR cell and such messages can benefit from the single frequency network (SFN) performance caused by multiple TRPs sending the same signal, with all the participating TRPs/beams transmitting the corresponding control and data messages, using the same RS sequence and content for the control message and the same RS sequence and content for the data message for transmitting the system information. UEs share the SI-RNTI (system information—radio network temporary identifier) to receive the system information. In accordance with an embodiment of the invention, the SI-RNTI is used for DMRS for both PDSCH carrying the system information message and PDCCH for carrying control information (e.g. resource allocation) for system information message. In another embodiment in order to avoid interference and collision of RS between adjacent cells, SI-RNTI and NR cell ID are used for DMRS for PDSCH carrying the paging message and PDCCH for carrying control information (e.g. resource allocation) for system information message to differentiate the system information between neighbouring cells. However, note that this is not UE-related, as the SI-RNTI is a fixed community ID.

RACH Phase—A random access channel is used by a UE to access the network. A random access procedure may include four messages each of which includes DMRS. The first and third messages are UL messages and the second and fourth messages are DL messages.

The first message is an UL message from a UE containing a randomly selected one of a set of available sequences, (for example, one of a set of 64 sequences having sequence indices 0 to 63) using one of a possible set of time slots (for example one of slots 0 to 9), A random access-RNTI (RA-RNTI) is associated with the slot number and frequency resource in which the preamble is sent and preamble index (RAPID) is the index of the sent sequence.

The second message is a random access response message addressed to the RA-RNTI determined from the sequence used in the first message. This message contains a temporary cell-radio network temporary identifier (C-RNTI) for further communications. The second message assigns an initial resource to the UE so that the UE can use an uplink shared channel. The second message uses the RA-RNTI for DMRS sequence and/or pattern for both physical downlink control channel (PDCCH) and physical downlink shared channel (PDSCH).

The third message is an RRC connection request message identified by the C-RNTI assigned in the previous message. The message contains a UE identity. The third message uses the RA-RNTI or C-RNTI for the DMRS for PDCCH and physical uplink shared channel (PUSCH).

The fourth message is a contention resolution message. The fourth message uses RA-RNTI or C-RNTI for PDCCH and PDSCH.

It should be understood this is a very specific example of a RACH procedure, and that UE specific RSs can be used in RACH procedures generally.

Regular communication—after completion of the RACH procedure described above, for the PDCCH, the UE ID or configurable ID are used for the associated DMRS. For the PDSCH, the UE ID or configurable ID are used for the associated DMRS. Optionally, a further cover code is applied which may, for example, be instructed by means of a field in the PDCCH.

### SRS Design

A specific example of how UE specific RS are used for SRS will now be described. In accordance with an embodiment of the invention, a UE-specific ID is used to determine an initialization sequence for a PN sequence that, in turn, is used to define the ZC sequence root of the ZC sequence used for SRS transmission. The ZC sequence root may also depend on other parameters such as sequence length and scheduling time.

In some embodiments, the seed used to initialize the PN sequence has a default value that is a function of a UE ID. In some embodiments, optionally, the default value can be overridden using RRC signaling to be a configurable ID.

Other attributes of the ZC sequence such as cyclic shift and scheduling time may also, or alternatively, have a default value derived from UE ID that can, again optionally, be overridden by RRC signaling.

In some embodiments, the one or more attributes of the ZC sequence/SRS transmission are based on a UE group ID (ID shared between a few UE) combined with a cover code which is UE specific (and not group specific).

In some embodiments, a block-wise SRS sequence that is comprised of multiple ZC sequences is used. In some embodiments, the attributes of each ZC sequence are determined so that the peak average power ratio (PAPR)/cubic metric (CM) of the whole sequence remains below an acceptable level.

### CSI-RS Design

A specific example of how UE specific RS are used for CSI-RS will now be described. In accordance with an embodiment of the invention, a UE ID or configurable ID is used for the CSI-RS. In the case of configurable ID, in some embodiments, this is based on a UE group ID.

In some embodiments, a hybrid approach is employed:

a. A UE ID based RS is used for CSI-RS for detailed beam management (to facilitate beam refinement and beam tracking) and for CSI acquisition within the refined beam; and
b. A configurable ID for CSI-RS is used for initial beam management (possibility of sharing with other UEs) and CSI acquisition within those beams.

### PN for UE Specific RS Design

In accordance with an embodiment, the PN sequence is initialized with a number that is a function of:

a. UE ID (initially) or a configurable ID. The UE ID may, for example be 16 bits.
b. Optionally, cell ID (e.g. 10 bits) or a cell specific configurable ID of the same length (i.e. 10 bits) or different length (e.g. 3 bits). The cell specific configurable ID may be carried in a system information block (SIB). Alternatively, a cell specific ID generates a separate cover code or randomizer that is applied to the resulting PN sequence.
c. Optionally, slot number (e.g. randomly selected slot for RACH access attempt)
d. Optionally, one or more other randomizer fields

In some embodiments, the above components are all included within a 31 bit initialization value. In some embodiments, to accommodate more than 31 bits, a longer PN code with a larger polynomial degree is employed, or a subset of the UE ID is used for sequence initialization, and the rest of the UE ID is used to specify RS pattern or a cover code or some other configuration to differentiate UEs.

### Detailed Embodiments for the PN Sequence Initialization

### First Embodiment: Use of Full UE ID and Cell Specific ID Utilization in the Randomization by Updating the Initializer Seed by Shortening the Width of Some Other Fields in the Initializer

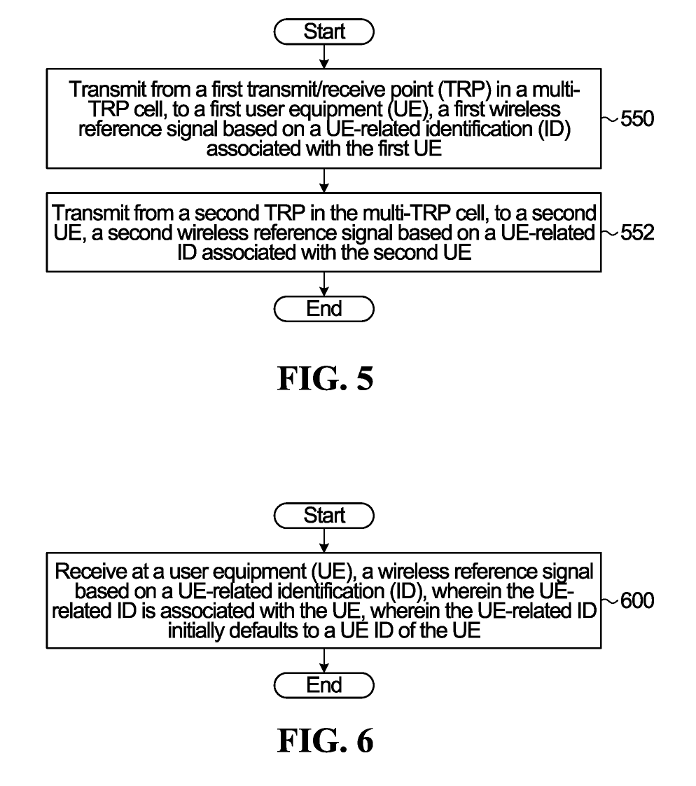

FIG. 4 shows an example in accordance with an embodiment of the invention of an initialization sequence suitable for use for DMRS in NR, generally indicated at 518. The sequence is a function of a first component 520 based on the slot number nₛ, a second component 522 that is a concatenation n_{ID}^{DMRS}, of the cell specific ID and UE ID (more generally a UE related ID, for example a configurable ID that defaults to the UE ID), and a third component containing n_{SCID} which can be 0 or 1. Note that the formula includes a factor 2⁵ which is equivalent to a 5 bit shift.

In some embodiments, the first component 520 is omitted.

In some embodiments the last component 524 is omitted. Alternatively, the last component 524 may be a two bit field, or a field of some other length. The inclusion of this field simply provides the possibility of multiple unique initialization sequences for the same combination of the other fields.

As noted above, the second component 522 is based on a concatenation of the cell ID and the UE ID. The UE ID may, for example, be 16 bits. More generally, any combination of the bits of the cell ID and the UE ID may be employed. This can include reversing the bits of one or both the cell ID and the UE ID, and/or interleaving bits of the two IDs for example.

FIG. 4 also shows an example in accordance with an embodiment of the invention of an initialization sequence suitable for use for CSI-RS in NR, generally indicated at 530. The sequence is a function of three components, including a first component 530 based on the slot number nₛ, a second component 532 that is a concatenation n_{ID}^{CSI}, of the cell specific ID and UE ID (more generally a UE related ID, for example a configurable ID that defaults to the UE ID), and a third component 534 containing n_{CP} which can be 0 or 1. Note that the formula includes a factor 2⁵ which is equivalent to a 5 bit shift.

Advantageously, with the approaches shown in FIG. 4, there is no need to update the PN sequence from existing implementations, and existing procedures for initialization can be employed, simply using the new sequence. With this approach, where the initialization sequence is 31 bits and the UE ID is 16 bits, the remaining 15 bits are available for other fields, including a cell specific element.

This approach is not limited to the specific initialization sequence, UE ID, cell ID lengths.

### Second Embodiment: Use of Full UE ID and Cell Specific ID Utilization in the Randomization by Using a Longer PN Sequence Generator (Applied on the Concatenation of UE ID and a Cell Specific ID) (can be Used as a Complementary Solution to the First Embodiment)

In a specific example, a concatenated cell specific ID and UE ID is 26 bits wide. Using this 26 bit field in combination with the other fields used in conventional LTE cᵢₙᵢₜ requires at least 7 extra bits bits which exceeds the 31 bits for the standard Gold sequences used for PN sequences. To accommodate longer initialization sequences, longer PN codes are used in this embodiment.

Three examples of generator polynomials for Gold sequences of longer lengths include:

Length 37: 1+X²+X¹⁴+X²²+X³⁷, 1+X³+X²¹+X³⁰+X³¹+X³³+X³⁷;

Length 41: 1+X³+X⁴¹, 1+X²⁷+X³¹+X³²+X⁴¹;

and

Length 63: 1+X²⁰+X⁴⁴+X⁵⁴+X⁶³, 1 +X⁵+X⁸+X¹⁸+X²²+X⁶⁰+X⁶³. Longer sequence generators opens up more room for different fields to be combined in the initialization. Note that this approach can be used in conjunction with the first embodiment, for different purposes, or at different stages.

### Third Embodiment: Use of Full UE ID and Cell Specific ID Utilization in the Randomization by Using a Function Combining Cell ID and UE ID to Generate a Shorter ID

In a specific example, the seed for the PN sequence is based on 4 bits of the cell ID concatenated with 10 bits of UE related ID.

With this approach, two UEs in the same cell will not collide.

Two UEs with the same UE ID in neighboring cells will not collide, since a UE receiving CSI-RS or DMRS with a particular UE ID will receive different RS sequences than a UE in a neighboring cell with the same UE ID.

However, there is still some collision probability in adjacent cells, where the combination of the cell ID and the UE ID result in the same initialization sequence for some permutations. This may be overcome by careful assignment of sequences and IDs among adjacent cells.

### Fourth Embodiment: Use Partial UE ID and Cell Specific ID Utilization in the Randomization, in which Case Some Bits in the UE ID and/or Cell Specific ID do not Contribute to the Randomizer but Rather Impact Other Aspects Such as RS Pattern

With this embodiments, some but not all of the bits in the UE ID are used for RS sequence initialization. Some of the bits are used to configure the RS time frequency resource.

In a specific example, for 16 bit UE ID, 12 bits are used for RS sequence initialization, and the remaining 4 bits indicate one of 16 possible patterns and/or sequence to resource mapping of the RS.

This approach utilizes other means of randomization and orthogonalization between different users (other than sequence).

In all the embodiments described herein, optionally, the cell specific ID and/or UE ID may be replaced after connection setup by a configurable ID through RRC signaling.

A combination of the above embodiments may be used, for example, using a longer PN generator used combined with partial ID usage.

### Embodiment—DMRS with Multiple TRPs Per NR Cell

Co-existence of multiple UEs in the same NR cell can be accommodated through the use of UE specific DMRS. In this case, there is randomized interference between the UEs.

A single frequency network (SFN) gain can be realized for paging and system information by using the same DMRS from multiple TRPs, as these will combine over the air and provide diversity gain.

For downlink RACH messages (second and fourth) using RA-RNTI, in some embodiments, the same DMRS is used for multiple TRPs in the region of a UE providing SFN gain.

In some embodiments, parallel second message and/or fourth message transmission is performed using the same RA-RNTI in geographically separate regions of the same cell. In this manner, two RACH access attempts from UEs in the same cell that transmit using the same RA-RNTI can both be accepted by the network.

### Embodiment—CSI-RS in NR with Multiple TRPs (for Example Ultra Dense Networks (UDN)

Case 1: UE specific CSI-RS

In some embodiments, each UE receives UE specific RS from a UE specific TRP/beam set. The UE specific RS may rely on UE ID (C-RNTI). UEs in the same vicinity may receive a group specific RS using a configured group ID.

### Case 2: Region Specific CSI-RS

Each region covered by a group of TRPs and/or beams is assigned a set of CSI-RS associated with a region ID (configured). UEs in each region are configured with CSI-RS through the configured CSI-RS ID.

### Embodiments—Single TRP Per NR Cell—CSI-RS

In some embodiments, CSI-RS is non-beam based, and the CSI-RS for the cell is defined by a configurable ID.

In some embodiments, the CSI-RS is beam-based. For each beam or set of beams a set of CSI-RS is defined associated with a CSI-RS ID.

All the UEs receive the CSI-RS configuration using the CSI-RS ID.

### Embodiments—Single TRP Per NR Cell—DMRS (Both DL and UL)

In some embodiments, for single user—multiple input multiple output (SU-MIMO) transmission schemes (applicable to UDN and beam based scenarios), a UE related DMRS is used based on UE ID.

In some embodiments, for multi-user MIMO (MU-MIMO) (also applicable to multi-TRP cell) a configurable DMRS ID for co-paired users is employed with a dynamic cover code for user separation.

### Configurable UE ID Length

In some networks, the UE ID length may be configurable.

In some embodiments, the PN sequence and Cᵢₙᵢₜ use the longest possible UE ID. If the UE ID is shorter than that, the extra bits are replaced with some known bits (such as all zeros or configurable). Alternatively, a function is used to extend the shorter UE ID to the longest possible UE ID.

In some embodiments, the PN sequence and Cᵢₙᵢₜ use a default length of UE ID, for example a UE ID length used for RA-RNTI and temp C-RNTI. Where the UE ID (or C-RNTI) is longer than default length, a configurable ID of the default length can be used. A function is used to derive the initialization ID of the default length from a longer UE ID.

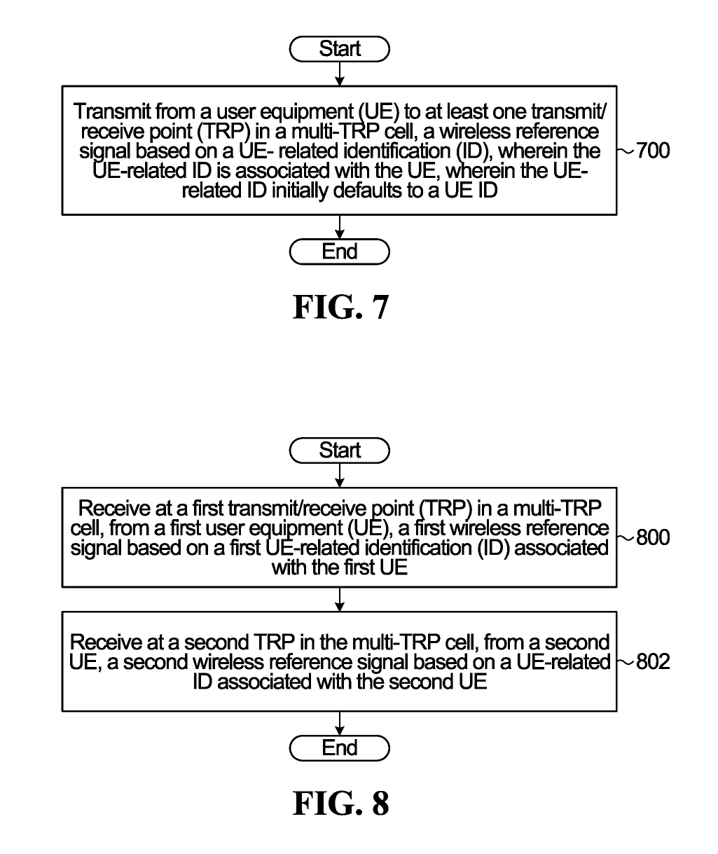

Referring now to FIG. 5, shown is a flowchart of a method provided by an embodiment of the disclosure. This method is executed by at least two TRPs of a multi-TRP cell. The method begins in block 500 with transmitting, from a first transmit/receive point (TRP) in a multi-TRP cell, to a first user equipment (UE), a first wireless reference signal based on a UE-related identification (ID) associated with the first UE. The method continues in block 502 with transmitting, from a second TRP in the multi-TRP cell, to a second UE, a second wireless reference signal based on a UE-related ID associated with the second UE. Optionally, each UE-related ID initially defaults to a UE ID.

Referring now to FIG. 6, shown is a flowchart of a method provided by an embodiment of the disclosure. This method is for execution by UE. The method involves receiving, at a user equipment (UE), a wireless reference signal based on a UE-related identification (ID), wherein the UE-related ID is associated with the UE, at block 600. The UE-related ID initially defaults to a UE ID of the UE

Referring now to FIG. 7, shown is a flowchart of a method provided by an embodiment of the disclosure. This method is for execution by UE. The method transmitting, from a user equipment (UE) to at least one transmit/receive point (TRP) in a multi-TRP cell, a wireless reference signal based on a UE-related identification (ID), wherein the UE-related ID is associated with the UE, at block 700. The UE-related ID initially defaults to a UE ID.

Referring now to FIG. 8, shown is a flowchart of a method provided by an embodiment of the disclosure. This method is for execution by at least two TRPs. The method begins in block 800 with receiving, at a first transmit/receive point (TRP) in a multi-TRP cell, from a first user equipment (UE), a first wireless reference signal based on a first UE-related identification (ID) associated with the first UE. The method continues in block 802 with receiving, at a second TRP in the multi-TRP cell, from a second UE, a second wireless reference signal based on a UE-related ID associated with the second UE. Optionally, each UE-related ID initially defaults to a UE ID.

Referring now to FIG. 9, shown is a flowchart of a method provided by an embodiment of the disclosure. This method is for execution by at least one TRP. The method involves receiving by at least one TRP, from a UE, a wireless reference signal based on a UE-related ID associated with the UE at block 900. The UE-related ID initially defaults to a UE ID of the UE.

For any of the methods of FIGS. 5 to 9, optionally, each wireless reference signal is based on the UE-related ID in that a PN sequence associated with the wireless reference signal is initialized with an initialization sequence containing some or all of the UE-related ID.

For any of the methods of FIGS. 5 to 9, optionally the PN sequence is directly associated with the wireless reference signal.

For any of the methods of FIGS. 5 to 9, optionally the PN sequence is used to configure a Zadoff Chu sequence that in turn is directly associated with the wireless reference signal.

For any of the methods of FIGS. 5 to 9, optionally each wireless reference signal is based on the UE-related ID in that at least one of:

resource elements used to transmit the RS;

periodicity; and

density in time and frequency;

is dependent on the UE related ID.

For any of the methods of FIGS. 5 to 9, optionally, at least one wireless reference signal is a demodulation reference symbol (DMRS) transmitted together with data or control information.

For any of the methods of FIGS. 5 to 9, optionally at least one wireless reference signal is a channel state information (CSI)-RS transmitted separate from data or control information.

For any of the methods of FIGS. 5 to 9, optionally at least one wireless reference signal is a sounding reference symbol (SRS) transmitted separate from data or control information.

For any of the methods of FIGS. 5 to 9, optionally after the UE-related ID initially defaults to the UE ID, the UE-related ID is a configured to be a shared UE ID.

For any of the methods of FIGS. 5 to 9, optionally the method further comprises configuring the UE-related ID to be a configurable ID, and thereafter transmitting or receiving the wireless reference signal based on a UE-related ID set to the configurable ID.

For any of the methods of FIGS. 5 to 9, optionally the wireless reference signal is also a function of a cell ID.

For any of the methods of FIGS. 5 to 9, optionally, the wireless reference signal is a function of a cell ID in that:

a PN sequence associated with the wireless reference signal is initialized with an initialization sequence containing some or all of the cell ID.

For any of the methods of FIGS. 5 to 9, optionally the wireless reference signal is a function of a cell ID in that:

a cell specific cover code is applied to the wireless reference signal

For any of the methods of FIGS. 5 to 9, optionally the wireless reference signal is based on a UE-related ID that is shared between a group of UEs, with a cover code that is specific to the UE and not shared by the group of UEs.

For any of the methods of FIGS. 5 to 9, optionally the wireless reference signal is based on a UE related ID in that a subset of a UE related ID is used for PN sequence initialization, and remaining portion of the UE related ID specifies a resource element pattern or a cover code or some other configuration to differentiate between UEs.

For any of the methods of FIGS. 5 to 9, optionally for multi-user MIMO, for co-paired UEs, after initially using a respective UE-related ID set to a respective UE ID for each UE, a configurable ID is used for DMRS for the co-paired users together with a respective cover code for each UE for UE separation.

### FURTHER NOTES AND EXAMPLES

LTE uses an RS scrambling ID that is 9 bits in length with a default value of the serving cell ID, and some existing proposals for RS scrambling IDs for NR cells involve a 10 bit length to match the NR cell ID length. Some of the embodiments described herein provide accommodation for wider RS scrambling IDs compared to these 9 and 10 bit lengths. Advantageously, the use of a wider RS scrambling ID decreases the probability of collision. A wider scrambling ID also increases the flexibility of RS planning as the RS pool becomes larger. The RS scrambling ID can be of the same length as the UE ID or RNTI (e.g. 16 bits). Other lengths such as 20 bits or 24 bits are possible.

The embodiments described herein involve the use of reference signals that are based on a UE-related ID. For example, the RS scrambling ID may be based on a UE-related ID. In some of the embodiments described, this initially defaults to a UE ID. However, more generally, for any of the embodiments described herein, an alternative is that there is no default value for the UE-related ID. In this case, the RS scrambling ID is UE-specifically configured.

In some of the embodiments described herein, the RS scrambling ID is associated with the UE-related ID, but is also based on the cell ID. It is to be noted that in the embodiments described herein, the RS scrambling ID is not associated with the cell ID as default.

Various examples of the RS initialization sequence (Cᵢₙᵢₜ) formula have been provided above. More generally, in some embodiments, the RS initialization seed is a function of:

RS scrambling ID;
Optionally: slot number;
Optionally: OFDM symbol number;
Remaining parameters:
Optionally: Specific RS (CSI-RS, DMRS, PT-RS) type, with respect to, for example, CP type, used channel (PDCCH, PDSCH, . . . )
Other identifiers and variables, for example a 1-bit or a bit-field dynamic randomizer in DMRS (to be included in the DCI) and/or CSI-RS identifier (e.g. beam management vs CSI acquisition)
Optionally: cell specific parameters.

Various formulas can be used to determine RS initialization sequence (Cᵢₙᵢₜ) based in a set of input parameters. In some embodiments, bit-field concatenation is used. In this case, the initialization seed just the various fields concatenated next to each other. A formula for the initialization see can be written as 2^{a} A+2^{b} B+2^{c} C+D where A, B, C and D are the parameters and a, b, and c are integers such that the bit-fields of A, B, C and D do not mix.

In some embodiments, Galois field (GF) Linear combination is used. In this case, a formula for the initialization seed combines the parameters using only XoRs between the bits of the parameters.

In some embodiments, an arithmetic Linear combination is used. In this case, the formula for the initialization seed uses only addition/subtraction, multiplication by a constant, and modulo operation with respect to a constant. No combining of the fields using multiplication or division is performed.

In some embodiments, a nonlinear combination is used. In this case, the formula for the initialization seed uses multiplication, division, or other non-linear elements.

Arithmetic linear, non-linear combinations and some GF linear combinations allow for randomized interference between two randomized sequences with different seeds as the time element changes. This means that if using scrambling ID 1 sequences s1 and s2 are generated at time stamps t1 and t2 and from scrambling ID 2, sequences u1 and u2 are generated at time stamps t1 and t2, the cross-correlation between s1 and u1 defined as c1 is statistically independent from the cross correlation s2 and u2 defined as c2.

Examples of Possible Elements used in Cᵢₙᵢₜ Calculation

In some embodiments, the following elements are used:

Slot number nₛ. (in this embodiment assumed up to 8 bits);
OFDM symbol number I. (in this embodiment assumed up to 4 bits);
RS scrambling ID: N_{RSID} (in this embodiment assumed to be the same length as UE ID or RNTI e.g. 16 bits). Other lengths such as 20 bits or 24 bits are possible;
Remaining parameters: P_{remaining} (in this embodiment assumed to be up to 3 bits—These bits incorporate the remaining parameters, for example as referred to above).

Other general formulas using functions of the above parameters are possible.

The following is an example of a general formula based on the above summarized elements, where f, g, and h are three functions, and where f, g and h are not necessarily all present:

Cᵢₙᵢₜ=2^{M}f(nₛ,l,N_{RSID})+2^{N}g(N_{RSID})+2^{Q}h(P_{remaining})

In a first example based on the general formula:

Cᵢₙᵢₜ=2^{M}(pnₛ+l+q)(2N_{RSID}+1)+P_{remaining}

where p≥14 (as 0≤l≤3) and q=1 or q=15. In the first example, there is no g function, and the h function is just the identify function.

In a second example based on the general formula, where just bit concatenation is used, and f, g, and h are all present:

Cᵢₙᵢₜ=2^{M}(14nₛ+l+1)+2^{N}N_{RSID}+P_{remaining}

In a third example based on the general formula,

Cᵢₙᵢₜ=2^{M}(p(14nₛ+l+1)+qN_{RSID})mod 2^{N}+P_{remaining}.

where p and q are odd co-prime numbers, M≥2, N≥16 and M+N≤31. In the above examples, f, g, and h may be substituted by other options, or different arrangement of the functions in the above examples may be used. Note that in general, the formulas, and the constants in the formulas should be selected so that the maximum length Cᵢₙᵢₜ (in binary representation) is within a specified PN maximum length (e.g. 31 or 63).

Note that formula for Cᵢₙᵢₜ can be defined that include a mod operation and/or a floor operation. For example, the example formulas presented above can be adjusted to include mod and or floor operation. Note that the special case (where mod and floor functions are against integer exponents of 2),

X mod 2^{L}

equals the last L bits (.e. keep the L least significant bits) of the X and

$$⌊ \frac{X}{{2}^{K}} ⌋$$

equals X discarding the last K bits (i.e. keep the M−K most significant bits, where X is an M-bit field).

The following is a modified version of the third example above, that now includes mod and floor operations:

$${C}_{init} = {2}^{M} \{ ( {pn}_{s}^{′} + l + q ) ( 2 {N}_{RSID} + 1 ) \} mod {2}^{L} + {2}^{N} ⌊ \frac{{N}_{RSID} mod {2}^{S}}{{2}^{K}} ⌋ + {P}_{remaining}$$

where N≥16 and n′ₛ=nₛ mod 20.

### Inter-Cell and Intra-Cell Interference Planning

In some embodiments, two RS ports (CSI-RS or DMRS) from two nearby beams/TRPs (that are not co-paired using cover codes, where the same PN sequence combined with an orthogonal cover code generates two or multiple orthogonal antenna ports) have different scrambling IDs to randomize the interference. In some embodiments, this can be achieved using planning.

In some embodiments, scrambling IDs in the same cell are planned to be different.

In some embodiments, scrambling IDs for different cells are randomly chosen. In this case, there is a certain possibility of seed collision that is inversely proportional to 2^{ID}^{_}^{Length}, where ID_length is the length of the scrambling ID.

In some embodiments, scrambling IDs can be carefully planned. In a first specific example, N_{RSID}=2¹⁰ P+CELL_ID where P is an integer from 0 to 63. In a second specific example, each cell is assigned a color index C (for example a color index between 0 and 7) and N_{RSID}=2³ P+C where C is the color index between 0 and 7 and P is an integer between 0 and 8191. In both of these examples, the UE does not need to know how N_{RSID} is determined.

In some embodiments, if a UE moves from one cell to another cell, it may keep its seed until reconfigured. In this case, effectively, a cell has lent one possible seed to its neighbor cell.

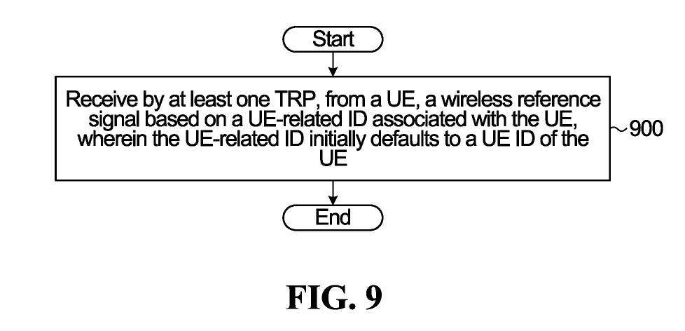

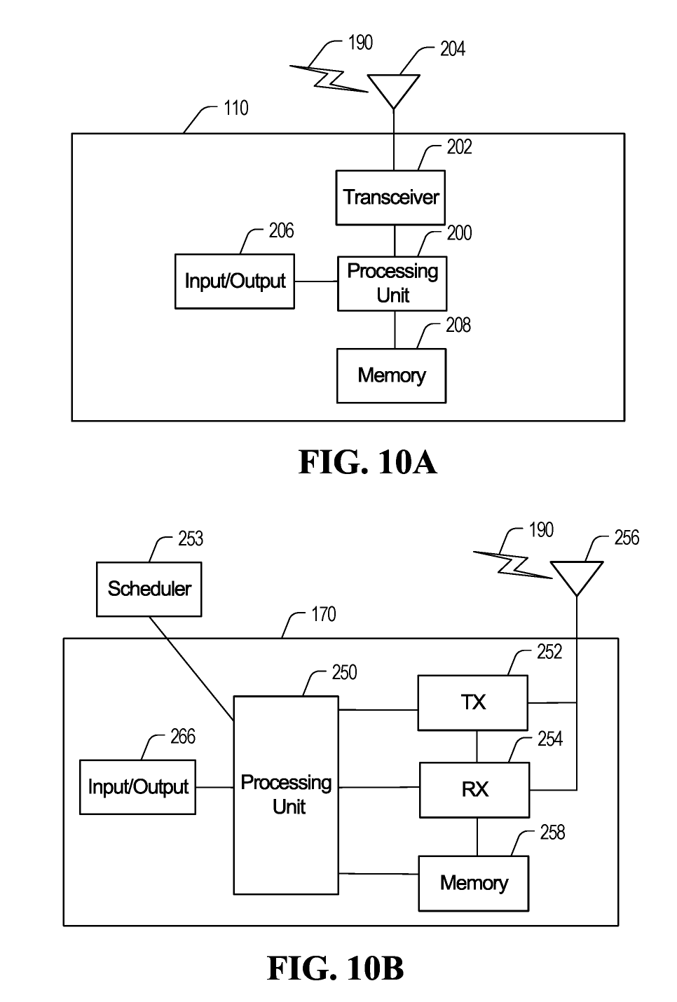

FIGS. 10A and 10B illustrate example devices that may implement the methods and teachings according to this disclosure. In particular, FIG. 10A illustrates an example ED 110, and FIG. 10B illustrates an example base station 170. These components could be used in the system 100 or in any other suitable system.

As shown in FIG. 10A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the system 100. The processing unit 200 may also be configured to implement some or all of the functionality and/or embodiments described in more detail above. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or NIC (Network Interface Controller) 204. The transceiver 202 is also configured to demodulate data or other content received by the at least one antenna 204. Each transceiver 202 includes any suitable structure for generating signals for wireless transmission and/or processing signals received wirelessly or by wire. Each antenna 204 includes any suitable structure for transmitting and/or receiving wireless signals. One or multiple transceivers 202 could be used in the ED 110, and one or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces. The input/output devices 206 facilitate interaction with a user or other devices (network communications) in the network. Each input/output device 206 includes any suitable structure for providing information to or receiving/providing information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like

As shown in FIG. 10B, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless signals. While a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 facilitates interaction with a user or other devices (network communications) in the network. Each input/output device 266 includes any suitable structure for providing information to or receiving/providing information from a user, including network interface communications.

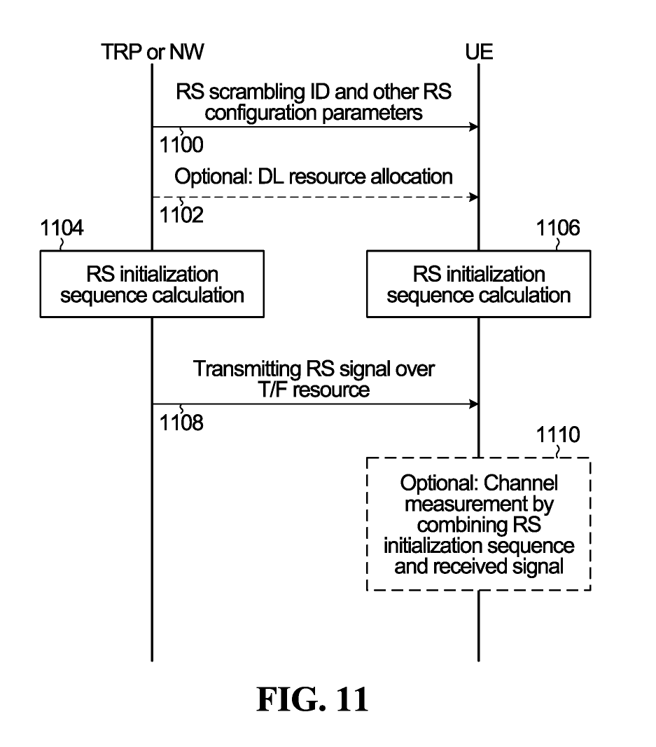

Referring now to FIG. 11, shown is a call flow diagram for an uplink call flow provided by an embodiment of the invention. The call flow of FIG. 11 shows communication steps between the network (for example a TRP) and a UE, and also shows steps performed by one or the other of the network and the UE. It is noted that this particular embodiment is specific to non-random access communication, for example regular communications that follow an initial random access or other initialization phase.

The call flow begins with transmitting, from a TRP, to a UE, a reference signal (RS) scrambling identification (ID) associated with the UE at 1100. Optionally, this is followed by downlink resource allocation at 1102. Next, at 1104, the network calculates a RS initialization sequence based on the RS scrambling ID, and at 1106, the UE also calculates a RS initialization sequence based on the RS scrambling ID. Next the TRP transmits a reference signal over a time/frequency resource, based on the calculated RS initialization sequence, to the UE. Optionally, the UE then performs channel measurement by combining the RS initialization sequence and the received signal.

Optionally, the call flow also includes transmitting, from the TRP to the UE, at least one of: a cell ID, a slot number, a symbol number, a RS type, a cyclic prefix type, or a transmission channel. In this case, the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, communicating the reference signal comprises receiving, by the UE, a received reference signal from the TRP.

Optionally, the reference signal is a demodulation reference symbol or a sounding reference symbol.

Optionally, communicating the reference signal comprises transmitting, by the TRP, the reference signal to the UE.

Optionally, the reference signal is a demodulation reference symbol or a channel state information reference signal.

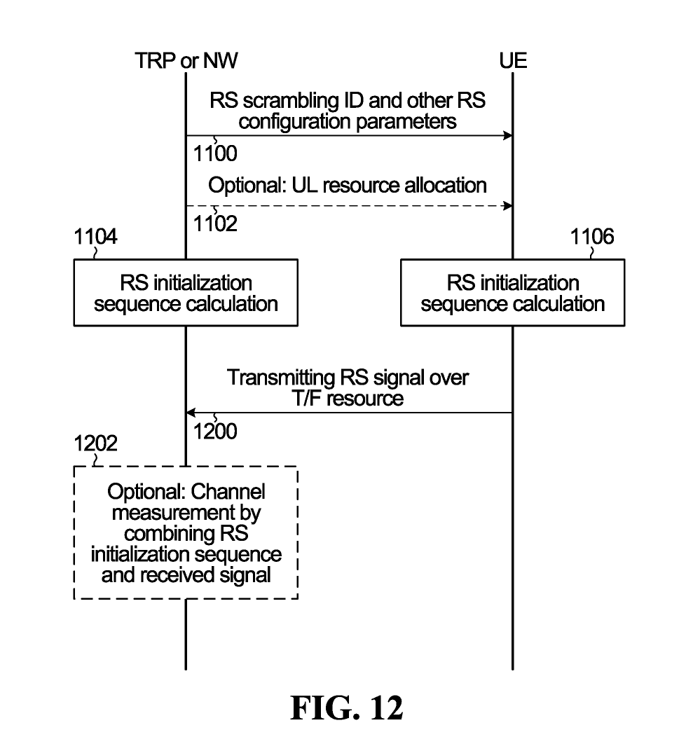

Referring now to FIG. 12, shown is a call flow diagram for a downlink call flow provided by an embodiment of the invention. The call flow of FIG. 12 shows communication steps between the network (for example a TRP) and a UE, and also shows steps performed by one or the other of the network and the UE. It is noted that this particular embodiment is again specific to non-random access communication.

Some of the steps are the same as FIG. 11, and will not be described again. In the call flow of FIG. 12, after RS initialization sequence calculation, the call flow continues with the UE transmitting a RS signal over a time/frequency resource at 1200.

Optionally, the call flow also includes the UE receiving, from the TRP, at least one of: a cell ID, a slot number, a symbol number, a RS type, a cyclic prefix type, or a transmission channel. In this case, calculating the RS initialization sequence is further based on the at least one of the cell ID, the slot number, the symbol number, the RS type, the cyclic prefix type, or the transmission channel.

Optionally, the RS scrambling ID is based on a UE-related ID that is associated with the first UE.

Optionally, communicating the reference signal comprises transmitting, by the UE, a received reference signal to the TRP.

Optionally, at 1202, the TRP also combines the received reference signal with the calculated RS initialization sequence, for measuring a downlink channel of the received reference signal.

Optionally, the reference signal is a demodulation reference symbol or a channel state information reference signal.

Optionally, wherein communicating the reference signal comprises receiving, by the TRP, the reference signal from the UE.

Optionally, reference signal is a demodulation reference symbol or a sounding reference symbol.

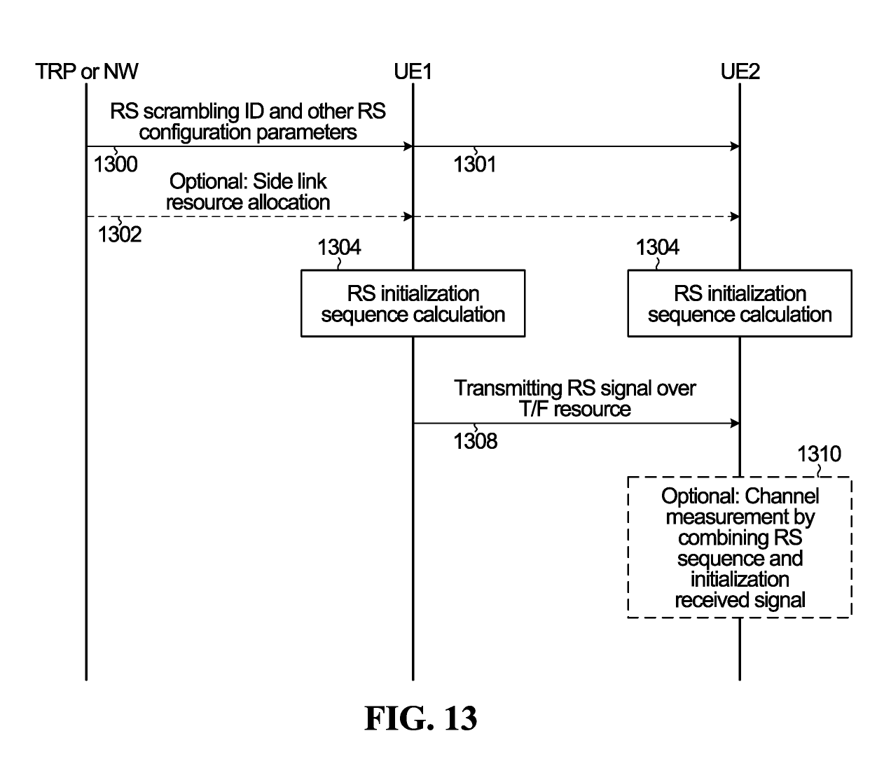

Referring now to FIG. 13, shown is a call flow diagram for a sidelink call flow provided by an embodiment of the invention. The call flow of FIG. 13 shows communication steps between the network (for example a TRP) and a first UE UE1, and a second UE UE2, and also shows steps performed by one or the other of the network and the two UEs. It is noted that this particular embodiment is again specific to non-random access communication.

The call flow optionally begins at 1300 with the network configuring the first UE UE1 with RS scrambling ID as in other embodiments. Optionally, the network also performs resource allocation at 1302 for a side link between the two UEs UE1, UE2. At 1301, UE1 transmits to UE2, a reference signal (RS) scrambling identification (ID) associated with the second UE. At 1304 and 1306, both UE1 and UE2 calculate an RS initialization sequence. At 1308, UE1 transmits a reference signal to UE2, the reference signal based on the RS initialization sequence.

Optionally, the call flow further includes transmitting, from the TRP to both UEs, at least one of: a cell ID, a slot number, a symbol number, a RS type, a cyclic prefix type, or a transmission channel. In this case, calculating the RS initialization sequence is further based on the at least one of the cell ID, the slot number, the symbol number, the RS type, the cyclic prefix type, or the transmission channel.

Optionally, the method of claim 1, wherein the RS scrambling ID is also based on a UE-related ID that is associated with the first UE.

Optionally, the reference signal is a demodulation reference symbol or a channel state information reference signal.

Note that further embodiments of the invention provide for the part of the call flow of FIG. 13 performed by the first UE1, and the second UE2, respectively.

In either the downlink (DL) case (FIG. 11), uplink (UL) case (FIG. 12), or sidelink (SL) case (FIG. 13), the network provides the RS scrambling ID and other required configuration information to the UE or UEs. The

RS configuration may involve semi-static and/or higher layer signaling such as RRC. Optionally, for the case of grant-based DL, UL, or SL transmission a dynamic or semi-static time/frequency resource allocation signal is sent to the UE to determine the time/frequency resource allocated for data transmission which in turn determines the time/frequency resources for the accompanying RS (such as DMRS) in that resource allocation message. PDCCH or RRC may, for example, be used for the resource allocation message. Alternatively, the time frequency resources assigned for RS is included in the RS configuration in the first message.

In case of DL (FIG. 11), the network or a TRP or a TRP set in the network is assigned to transmit the RS and a UE or group of UEs is assigned to receive the RS.

In case of UL (FIG. 12), the network a TRP or TRP set in the network is assigned to receive the RS and a UE or group of UEs is assigned to transmit the RS.

In case of SL (FIG. 13), a UE or group of UEs is assigned to transmit the RS and a UE or group of UEs is assigned to receive the RS. Note that the RS ID configuration message, and the optional resource allocation message may be sent to different UEs using broadcast or unicast messages.

In all three examples, both the transmit and receive side calculate the RS initialization sequence using the RS scrambling ID, combined with optionally one or a subset of other parameters in the RS configuration, time stamp, information in the resource allocation message and other network parameters.

The transmit side transmits the reference signal based on the RS initialization sequence over the time/frequency resources assigned by the RS configuration and/or the optional resource allocation message.

The receive side if desired may measure or estimate the channel by combining the received reference signal over the allocated time/frequency resource and the RS initialization sequence earlier calculated at the receive side.

Further Embodiments for DMRS Initialization

In the following embodiments, the cell ID is 10 bits, C-RNTI and other RNTIs are 16 bits. Other parameters such as slot number are also being used.

A general formula for the initialization is as follows:

Cᵢₙᵢₜ=F(ID_{DMRS},nₛ, other parameters)

where ID_{DMRS} is the DMRS seed ID (a specific example of RS scrambling ID that is specific to DMRS for this embodiment) which is configurable, nₛ is the slot number.

In a first example, ID_{DMRS} is larger than the cell ID up to the same size of UE ID (16 bit in this example). For broadcast messages using common

RNTIs such as (P-RNTI, SI-RNTI and RA-RNTI, ID_{DMRS} is cell ID or a function of cell ID. Examples of the possible aspects of function F include:
Padding zeros or fixed bit strings of 0s and 1s to the left and/or right of cell ID;
Repeating some bit fields of Cell ID; and
Hash functions

For the first example, for unicast messages after RRC connection setup, ID_{DMRS} is set using the configurable ID used in the RRC configuration (of 16 bits in this example). In some embodiments, there is a default value for ID_{DMRS}.

In a second example, ID_{DMRS} is the same size of UE ID (16 bit in this example). For broadcast messages using common RNTIs such as (P-RNTI, SI-RNTI and RA-RNTI), ID_{DMRS} is a combination of cell ID and another field representing the RNTI. In some embodiments, this involves concatenating a cell ID (10 bits) with a short identifier representing the RNTI (6 bits in this example). A lookup table can be used to map the common RNTIs to the short identifier (up to 64 different identifiers).

For the second example, for unicast messages after RRC connection setup, ID_{DMRS} is set using the configurable ID via RRC configuration (16 bits in this example). Alternatively, ID_{DMRS} is set using the cell ID (10 bits) concatenated with the configurable ID by RRC signaling (6 bits). Use of a default value is not precluded.

In a third example, ID_{DMRS} has a larger size compared to UE ID (>16 bit in this example). For broadcast messages using common RNTIs such as (P-RNTI, SI-RNTI and RA-RNTI), ID_{DMRS} is a combination of cell ID and another field representing the RNTI. For example, this can involve concatenating Cell ID (10 bits) with a short identifier representing the RNTI (>6 bits in this example). As before, a lookup table can be used to map the common RNTIs to the short identifier (>64 different identifiers).

For the third example, for unicast messages after RRC connection setup, ID_{DMRS} is set using the configurable ID via RRC configuration (>16 bits in this example). Alternatively, ID_{DMRS} is set using the cell ID (10 bits) concatenated with the configurable ID by RRC signaling (>6 bits). Use of a default value is not precluded.

In some embodiments, the initialization for DMRS in DL, UL and sidelink use the same or different RS initialization sequence, and/or parameters and/or functions.

In some embodiments, CSI-RS initialization uses the same mechanism as DMRS initialization. In such embodiments, ID_{CSI-RS} is used to initialize the CSI-RS and other parameters and functions are reused between DMRS and CSI-RS.

In some other embodiments, the mechanism described above is used for CSI-RS initialization. In such embodiments, ID_{CSI-RS} is used to initialize the CSI-RS. The specific parameters and/or functions used for DMRS initialization and CSI-RS initialization may be different.

In some embodiments, the same mechanism as DMRS is used for initializing the phase tracking reference signal (PT-RS) sequence. PT-RS is a reference signal used for tracking the phase of the wireless channel as a result of Doppler shift, Doppler spread, local oscillator phase jitter or a combination thereof. The RS initialization sequence used for PT-RS may be the same or different from those of DMRS. PT-RS may optionally use the same set of parameters and/or functions for initialization of PT-RS compared to those of DMRS.

### Further Embodiments for CSI-RS Initialization

In a specific example, the following formula is used to calculate Cᵢₙᵢₜ for CSI-RS initialization:

cᵢₙᵢₜ=2^{b}·(14·(mod(nₛ,X)+1)+l+1)·└(2·N_{ID}^{CSI}+1)/q₂┘+2^{a}·└(N_{ID}^{CSI})/q₁+RS_{type}

where:
N_{ID}^{CSI} is an RS scrambling ID for the CSI-RS, more than 10 bits, for example 16 bits;
q₁ and q₂ are two different prime numbers and a and b and X are determined so that the length of cᵢₙᵢₜ is at most 31 bits. Alternatively, q₁ and q₂ are two different co-prime numbers.

Note that X can be large enough so that mod(nₛ, X)=nₛ for all nₛ in the radio frame.

The following is a specific example of the above formula for a 16 bit N_{ID}^{CSI}:

$${c}_{init} = {2}^{11} \cdot \underbrace{( 14 \cdot ( mod ( {n}_{s} , 20 ) + 1 ) + l + 1 )}_{9 bits} \cdot \underbrace{⌊ ( 2 \cdot {N}_{ID}^{CSI} + 1 ) \text{/} 79 ⌋}_{11 bits} + 2 \cdot \underbrace{⌊ ( {N}_{ID}^{CSI} ) \text{/} 89 ⌋}_{10 bits} + \underbrace{{RS}_{type}}_{1 bit}$$

In another specific example, the following formula is used to calculate Cᵢₙᵢₜ for CSI-RS initialization:

cᵢₙᵢₜ=2^{b}·(14·(mod(nₛ,X)+1)+l+1)·└(2·└N_{ID}^{CSI}/2^{c}┘+1)+2^{a}·mod(N_{ID}^{CSI},2^{d})+RS_{type}

where:
N_{ID}^{CSI} is an RS scrambling ID for CSI-RS, more than 10 bits, for example 16 bits; a, b, c, d, X are determined so that the length of cᵢₙᵢₜ Is at most 31 bits.

The following is a specific example of the above formula for 16 bits N_{ID}^{CSI}:

$${c}_{init} = {2}^{10} \cdot \underbrace{( 14 \cdot ( {n}_{s} + 1 ) + l + 1 )}_{12 bits} \cdot \underbrace{( 2 \cdot ⌊ {N}_{ID}^{CSI} \text{/} {2}^{8} ⌋ + 1 )}_{9 bits} + {2}^{2} \cdot \underbrace{mod ( {N}_{ID}^{CSI} , {2}^{8} )}_{8 bit} + \underbrace{{RS}_{type}}_{2 bit}$$

Note that can X be large enough so that mod(nₛ, X)=nₛ for all nₛ in that in radio frame.

In another specific example, the following formula is used to calculate Cᵢₙᵢₜ for CSI-RS initialization:

cᵢₙᵢₜ=2^{b}·((p₁·(14·(mod(nₛ,X)+1)+l+1))+p₂·(2·N_{ID}^{CSI}+1))mod 2^{c}+2^{a}└N_{ID}^{CSI}/8┘+RS_{type}

where:

N_{ID}^{CSI} is an RS scrambling ID for CSI-RS, more than 10 bits, for example 16 bits; a, b, c, p₁, p₂, X are determined so that the length of cᵢₙᵢₜ is at most 31 bits. p₁ and p₂ are two different prime numbers.

The following is a specific example of the above formula for 16 bits N_{ID}^{CSI}:

$${c}_{init} = {2}^{15} \cdot \underbrace{( ( {p}_{1} \cdot ( 14 \cdot ( {n}_{s} + 1 ) + l + 1 ) ) + {p}_{2} \cdot ( 2 \cdot {N}_{ID}^{CSI} + 1 ) ) mod {2}^{16}}_{16 bits} + {2}^{2} \underbrace{⌊ {N}_{ID}^{CSI} \text{/} 8 ⌋}_{13 bits} + {RS}_{type} ,$$

where p₁=181, p₂=101. Note that X can be large enough so that mod(nₛ, X)=nₛ for all nₛ in that in radio frame.

In another specific example, the following formula is used to calculate Cᵢₙᵢₜ for CSI-RS initialization:

cᵢₙᵢₜ=2^{b}·(14·(mod(nₛ,X)+1)+l+1)·└2·N_{ID}^{CSI}/q₂+1┘2^{a}·mod(N_{ID}^{CSI},q₁)+RS_{type}

### Where:

N_{ID}^{CSI} is an RS scrambling ID for CSI-RS, more than 10 bits, for example 16 bits;

q₂ and q₁ are two different prime numbers and a and b and X are determined so that the length of cᵢₙᵢₜ is at most 31 bits. Alternatively, q₁ and q₂ are two different co-prime numbers. Note that X can be large enough so that mod(nₛ, X)=nₛ for all nₛ in the radio frame.

The following is a specific example of the above formula for 16 bits N_{ID}^{CSI}:

$${c}_{init} = {2}^{11} \cdot \underbrace{( 14 \cdot ( mod ( {n}_{s} , 20 ) + 1 ) + l + 1 )}_{9 bits} \cdot \underbrace{⌊ 2 \cdot {N}_{ID}^{CSI} \text{/} 79 + 1 ⌋}_{11 bits} + 2 \cdot \underbrace{⌊ ( {N}_{ID}^{CSI} ) \text{/} 1021 ⌋}_{10 bits} + \underbrace{{RS}_{type}}_{1 bit}$$

In another specific example, the following formula is used to calculate Cᵢₙᵢₜ for CSI-RS initialization:

cᵢₙᵢₜ=2^{b}·mod((14·(mod(nₛ,X)+1)l+1)·(2·└N_{ID}^{CSI}/2^{d}┘+1),p₁)+2^{a}·mod((14·(mod(hₛ,Y)+1)+l+1)·(2·mod(N_{ID}^{CSI},2^{c})+1),p₂)+RS_{type}

where:
N_{ID}^{CSI} is an RS scrambling ID for CSI-RS, more than 10 bits, for example 16 bits;
p₂ and p₁ are two different prime numbers and a, b, c, d, X, Y are determined so that the length of cᵢₙᵢₜ is at most 31 bits.

Note that X, Y can be large enough so that mod(nₛ, X)=nₛ and mod(nₛ, Y)=nₛ for all nₛ in the radio frame.

The following is a specific example of the above formula for 16 bits N_{ID}^{CSI}:

cᵢₙᵢₜ=2¹⁶·mod((14·(mod(nₛ,20)+1)+l+1)·(2·└N_{ID}^{CSI}/2⁸┘+1),32719)+2·mod((14·(mod(nₛ,20)+1)+l+1)·(2·mod(N_{ID}^{CSI},2⁸)+1),32749)+RS_{type}

Note that for each of the 5 examples provided above for CSI-RS initialization, more generally, Cᵢₙᵢₜ has a length that is at most M, where M is a PN maximum length. For example M might be 31 or 63.

In some embodiments, DMRS initialization uses the same mechanism as CSI-RS initialization. In such embodiments, ID_{DMRS} is used to initialize the DMRS and other parameters and functions are reused between DMRS and CSI-RS.

In some other embodiments, the mechanism described above is used for DMRS initialization. In such embodiments, ID_{DMRS} is used to initialize the DMRS. The specific parameters and/or functions used for DMRS initialization and CSI-RS initialization may be different.

In some embodiments, the same mechanism as CSI-RS is used for initializing the time-frequency tracking TRS sequence. The RS initialization sequence used for TRS may be the same or different from those of CSI-RS. TRS may optionally use the same set of parameters and/or functions for initialization of PT-RS compared to those of CSI-RS.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1-25. (canceled)

26. A method for non-random access communication, the method comprising:
transmitting, from a transmit/receive point (TRP), to a user equipment (UE), a reference signal (RS) scrambling identification (ID) associated with the UE;
calculating a RS initialization sequence based on the RS scrambling ID; and
communicating a reference signal between the UE and the TRP, the reference signal based on the RS initialization sequence.

27. The method of claim 26, further comprising:
transmitting, from the TRP to the UE, at least one of: a cell ID, a slot number, a symbol number, a RS type, a cyclic prefix type, or a transmission channel; and
wherein calculating the RS initialization sequence is further based on the at least one of the cell ID, the slot number, the symbol number, the RS type, the cyclic prefix type, or the transmission channel.

28. The method of claim 26, wherein the RS scrambling ID is based on a UE-related ID that is associated with the first UE.

29. The method of claim 26, wherein communicating the reference signal comprises receiving, by the TRP, a received reference signal from the UE.

30. The method of claim 29, further comprising combining the received reference signal with the calculated RS initialization sequence, for measuring an uplink channel of the received reference signal.

31. The method of claim 30, wherein the reference signal is a demodulation reference symbol or a sounding reference symbol.

32. The method of claim 26, wherein communicating the reference signal comprises transmitting, by the TRP, the reference signal to the UE.

33. The method of claim 32, wherein the reference signal is a demodulation reference symbol or a channel state information reference signal.

34. A method for non-random access communication, the method comprising:
receiving, by a user equipment (UE), from a transmit/receive point (TRP), a reference signal (RS) scrambling identification (ID) associated with the UE;
calculating a RS initialization sequence based on the wireless RS scrambling ID; and
communicating a reference signal between the UE and the TRP, the reference signal based on the RS initialization sequence.

35. The method of claim 34, further comprising:
receiving, from the TRP, at least one of: a cell ID, a slot number, a symbol number, a RS type, a cyclic prefix type, or a transmission channel; and
wherein calculating the RS initialization sequence is further based on the at least one of the cell ID, the slot number, the symbol number, the RS type, the cyclic prefix type, or the transmission channel.

36. The method of claim 34, wherein the RS scrambling ID is based on a UE-related ID that is associated with the first UE.

37. The method of claim 34, wherein communicating the reference signal comprises receiving, by the UE, a received reference signal from the TRP.

38. The method of claim 37, further comprising combining the received reference signal with the calculated RS initialization sequence, for measuring a downlink channel of the received reference signal.

39. The method of claim 38, wherein the reference signal is a demodulation reference symbol or a channel state information reference signal.

40. The method of claim 34, wherein communicating the reference signal comprises transmitting, by the UE, the reference signal to the TRP.

41. The method of claim 40, wherein the reference signal is a demodulation reference symbol or a sounding reference symbol.

42. A transmit/receive point (TRP) comprising:
a transmitter and a receiver;
a processing unit and memory;
the TRP configured to transmit to a UE a reference signal (RS) scrambling identification (ID) associated with the UE, calculate a RS initialization sequence based on the RS scrambling ID, and communicate a reference signal between the UE and the TRP, the reference signal based on the RS initialization sequence.

43. The TRP of claim 42, wherein the RS scrambling ID is based on a UE-related ID that is associated with the first UE.

44. The TRP of claim 42, configured to communicate the reference signal by receiving the reference signal from the UE.

45. The TRP of claim 42, configured to communicate the reference signal by transmitting the reference signal to the UE.

46. A user equipment (UE) comprising:
a transmitter and a receiver;
a processing unit and memory;
the UE configured to receive from a transmit/receive point (TRP), a reference signal (RS) scrambling identification (ID) associated with the UE, to calculate a RS initialization sequence based on the RS scrambling ID, and to communicate a reference signal between the UE and the TRP, the reference signal based on the RS initialization sequence.

47. The UE of claim 46, wherein the RS scrambling ID is based on a UE-related ID that is associated with the first UE.

48. The UE of claim 46, configured to communicate the reference signal by receiving the reference signal from the TRP.

49. The UE of claim 46, configured to communicate the reference signal by transmitting the reference signal to the TRP.

50-57. (canceled)
